(19) United States
(12) Patent Application Publication
(10) Pub. No.: US 2012/0101897 A1
(43) Pub. Date: Apr. 26, 2012

(54) ROBUST TAGGING SYSTEMS AND METHODS

(76) Inventor: Adam Vital, III, Atlanta, GA (US)

(21) Appl. No.: 13/380,953

(22) PCT Filed: Jun. 25, 2010
(86) PCT No.: PCT/US10/40099

§ 371 Date: Dec. 27, 2011

Related U.S. Application Data
(60) Provisional application No. 61/220,471, filed on Jun. 25, 2009.

(51) Int. Cl. G06Q 30/02

(52) U.S. Cl. 705/14.49

(57) ABSTRACT

Systems and method for tagging people, objects, events, and other targets are described herein. A tagging method can include receiving an indication of a media file representing a target, and receiving a description of the target. An external web address affiliated with a sponsor can also be received. The received information can then be included in a robust tag, which can be associated with the media file in exchange for payment from the sponsor. When the media file is later displayed to a user, a representation of the robust tag can be presented with the media file, thus enabling the sponsor to market itself to the user.

### CROSS-REFERENCE TO RELATED APPLICATION

This application claims a benefit, under 35 U.S.C. §119(e), of U.S. Provisional Application Ser. No. 61/220,471, filed 25 Jun. 2009, the entire contents and substance of which are hereby incorporated by reference.

### TECHNICAL FIELD

Various embodiments of the present invention relate to tagging systems and, more particularly, to robust tagging systems for identifying people, merchandise, places, events, or other targets.

### BACKGROUND

Social networking websites implement tagging to facilitate networking. For example, a user uses a mouse cursor to select a “tagged” person's face within a photograph. When prompted, the user enters the tagged person's name to associate the selected area of the photograph with the tagged person. When the photograph is viewed later, the social networking website indicates that the tagged person appears in the photograph. The website can also provide a link to an internal profile page of the tagged person. When a user visits the profile page of the tagged person, the user can view information about the tagged person and perhaps browse other photographs in which the tagged person has been tagged. Thus, the user can learn more about the tagged person and can initiate a networking relationship with the tagged person.

Conventionally, tagging is a means for digitally describing and identifying a person in a photograph. For instance, a website implementing a tagging system can include photographs, as well as internal profiles of website users. A user of the website can tag a person in a photograph available on the website. Later, when another user views the tagged photograph on the website, the other user can follow a link associated with the photograph to the internal profile of the tagged person. Tagging can sometimes lead to effective identification by enabling users to label people depicted in tagged photographs, so that other users can view these labels.

Conventional tagging is limited in that a tag associates a pictured person only with the pictured person's identity and internal profile. Unfortunately, conventional tagging does not provide extended details about the tagged person and does not enable access to external resources for gathering further information about the tagged person. In short, conventional tagging systems are bound by the websites in which they operate.

### SUMMARY

There is a need for a robust tagging system that can link users to external resources for gathering additional information related to a tagged target. It would be desirable for such a tagging system to allow a user to complete data fields relating to the target. It would be further desirable for the tagging system to enable tagging of people, as well as merchandise, places, events, and various other targets. It is to such a tagging system and methods for providing and using a tagging system, that various embodiments of the invention are directed.

Briefly described, various embodiments of the present invention relate to robust tagging systems and methods for providing and using same. According to some exemplary embodiments of the present invention, tagging systems can create and support robust tags incorporating details and external resources relating to targets of the tags. A tagging system can include, for example, a request unit, a tagging unit, and a display unit.

The request unit of the tagging system can receive requests from sponsors and consumers for tag creation. Tag creation requests from sponsors can be fulfilled if accepted by the tagging system and accompanied by some form of payment for the sponsor's being associated with the media file. The tagging unit can create robust tags in response to tag requests accepted by the tagging system. In addition to identification of the target in the media file, a robust tag can also contain a link to an external web resource affiliated with the sponsor who purchased the robust tag. The search unit can search media files accessible by the tagging system and can present media files to users, along with applicable robust tags associated with the media files. The display unit can display media files and their robust tags to users.

These and other objects, features, and advantages of the tagging system will become more apparent upon reading the following specification in conjunction with the accompanying drawing figures.

### BRIEF DESCRIPTION OF THE FIGURES

FIG. 1 illustrates a diagram of an environment of a tagging system, according to an exemplary embodiment of the present invention.

FIG. 2 illustrates an architecture of a client computer of a tagging system, in accordance with an exemplary embodiment of the present invention.

FIG. 3 illustrates an architecture of a server assembly of the tagging system, according to an exemplary embodiment of the present invention.

FIG. 4 illustrates a display of a media file tagged by way of the tagging system, according to an exemplary embodiment of the tagging system.

FIG. 5 illustrates a flow chart of tagging process of the tagging system, according to an exemplary embodiment of the present invention.

FIG. 6 illustrates an exemplary display of search results provided by the tagging system, according to an exemplary embodiment of the present invention.

FIG. 7 illustrates a flow chart of a method of opening and closing a tag request, according to an exemplary embodiment of the present invention.

### DETAILED DESCRIPTION

To facilitate an understanding of the principles and features of the invention, various illustrative embodiments are explained below. In particular, the invention is described in the context of being a tagging system enabling sponsors to tag images for marketing purposes. Embodiments of the invention, however, are not limited to sponsor-tagging or to marketing purposes. Rather, tagging can be performed by end users, such as consumers or other entities, and can be used for various other purposes besides marketing, such as, for example, networking purposes.

The materials and components described hereinafter as making up various elements of the invention are intended to be illustrative and not restrictive. Many suitable materials and components that would perform the same or similar functions as the materials and components described herein are intended to be embraced within the scope of the invention. Other materials and components not described herein can include, but are not limited to, for example, analogous materials and components developed after development of the invention.

Various embodiments of the present invention are robust tagging systems, through which sponsors can tag media files. The tagging system can be implemented on a computing device (e.g., personal computer, personal digital assistant, smartphone, or digital reader) or a computer network (e.g., Internet, intranet, cloud network) and can thus be embodied in a computer-readable medium for execution by a computer processor. Referring now to the figures, in which like reference numerals represent like parts throughout the views, embodiments of the robust tagging system will be described in detail.

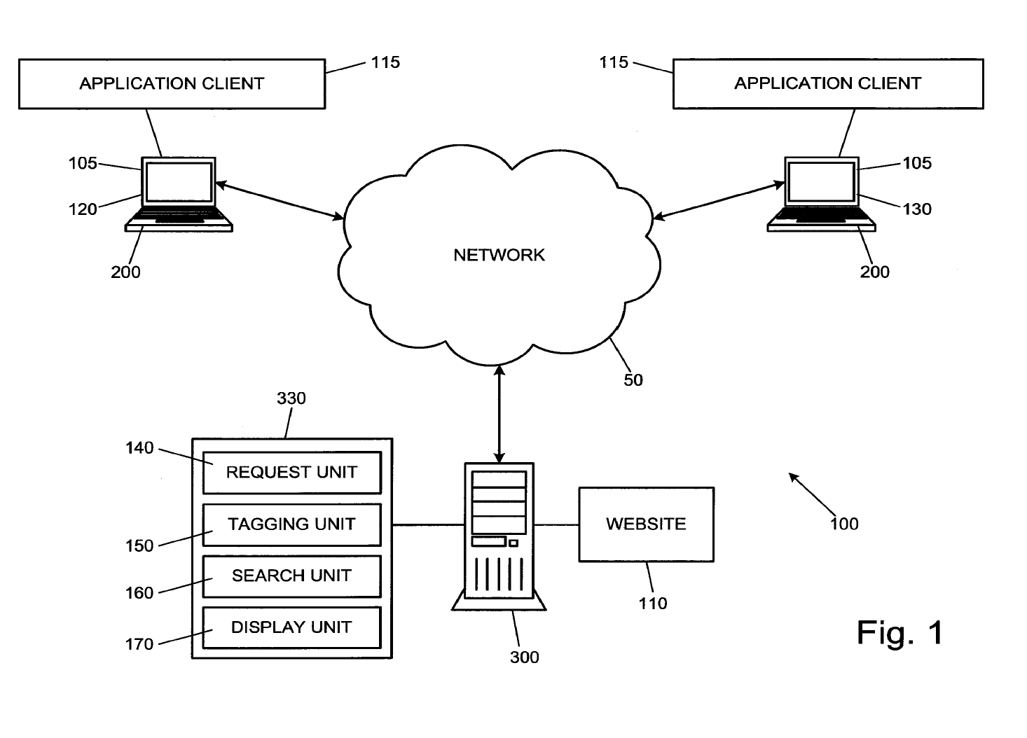

FIG. 1 illustrates a diagram of a robust tagging system 100, according to an exemplary embodiment of the present invention. As shown, the robust tagging system 100 can operate over a network 50, thus facilitating facilitate interaction between a server assembly 300 and one or more sponsors 120 and consumers 130 at client computers 200.

The tagging system 100 can be implemented in a server-client environment, in which the server assembly 300 can perform or dictate some or all of the operations of the robust tagging system 100. The server assembly 130 can transmit data to the client computers 200 for display to various users 105, such as sponsors 120 and consumers 130. In some embodiments of the tagging system 100, the server assembly 300 can provide services for a web site 110, which users 105 can access over the network 50 to use the tagging system 100. In lieu of, or in addition to, a website 110, a client application 115 can run on each client computer 200. The client application 115 can locally maintain some or all of the code for operation of the tagging system 100 and can communicate with the server assembly 300 over the network 50. Alternatively, in some embodiments, the robust tagging system 100 can be implemented in a pure peer-to-peer network or in a peer-to-peer network utilizing the server assembly 300 for file-indexing or other centralized functions.

If provided, the server assembly 300 can comprise or communicate with a storage device 330. The storage device 330 can contain a computer program product providing instructions for a processor to effectuate various units making up the tagging system 100. The units of the tagging system 100 can be programs, program modules, or other operative components of the tagging system 100. These units can comprise, for example, a request unit 140, a tagging unit 150, a search unit 160, and a display unit 170. Although these units are described as being distinct components of the tagging system 100, this need not be the case. The units are distinguished herein based on operative distinctiveness, but they can be implemented in various fashions, wherein the elements or components making up the various units can overlap or be divided in a manner other than that described below.

In general, the tagging system 100 provides more robust tagging than conventional tagging systems, and can thus enable sponsors to more effectively market their products and services. Embodiments of the present invention can associate a name with a portion of an image. Further, embodiments of the present invention can associate products, companies, and external web resources with various types of targets contained in or otherwise represented by media files.

Targets of tags can be people, merchandise, places, events, or various others elements capable of representation in a media file or other digital file. A user 105 can create a tag by selecting a portion of a media file representing a target, and then entering details related to the target. The user can also select an external web resource to be included in the tag, for example, in the form of a hyperlink. The external web resource can be an official page related to the target. For example, if the target is a piece of merchandise, the web resource can be a home page of the brand of the merchandise or an official product page of the merchandise. Details entered by the user 105, along with hyperlinks to selected web resources, can be incorporated into the tag and associated with the media file.

The tagging system 100 can facilitate ecommerce by enabling social networking systems, search engines, and other systems that may be dependent on advertising, to connect users to vendors in a noninvasive user-friendly fashion. Through tagging, a user of such systems, which can be a sponsor marketing its products, services, and events, can associate a name, description, or detail to a media file or a specific element or portion of a media file. The tagging system 100 can enable users 105 to quickly identify a person or thing in a media file and to link to external resources related to the person or thing. Instead of solely identifying a person in a photograph, embodiments of the present tagging system 100 can enable tagging of people, goods, services, places, events, merchandise, and various other targets. A tag from embodiments of the present tagging system can incorporate details and hyperlinks enabling a user to effectively pursue additional interest in the tagged target. Thus, an exemplary tag of the present invention can provide more than a mere identification and can thus be a tag profile, providing useful information and resources about the target or the media file representing the target.

According to exemplary embodiments, sponsors can create tags and associate them with media files. When creating a tag, or a tag profile, a sponsor can provide a title or description of the intended target of the tag in a media file and, if desired, can indicate a portion of the media file to which the title or description applies. When later associated with the media file, the tag can include various combinations of the following: an indication of the specified portion of the media file, the title or description of the target, the name of the sponsor, and one or more external web resources related to the sponsor or target of the tag in the media file. Consumers 130 can recommend that media files be tagged by relevant sponsors 120. If a sponsor 120 accepts such a recommendation, the sponsor 120 can purchase the tag and also compensate the applicable consumer 130 in some manner. For example and not limitation, the sponsor can compensate the consumer 130 by giving the consumer 130 money, real or virtual credit, a discount, a coupon, or other rewards.

In some further embodiments, a sponsor can purchase marketing space in search results provided in response to searches with selected search terms. For example, and not limitation, when a search engine returns a collection of media files as results of a search performed by a user 105, a predetermined number of pages or results of the results collection can be tagged with information provided by or associated with the sponsor. The number of media files tagged can be a number paid for by the sponsor. Thus, although a sponsor need not have specifically selected certain media files to be associated with the sponsor's tag, a predetermined number or page range of media files can be tagged when returned as search results. In an exemplary embodiment, a sponsor can purchase space in search results related to the sponsor's core business, so that consumers 130 need not be annoyed by tags unrelated to the consumers' search terms. Using spot-sharing, however, a sponsor 120 who has purchased space in search results can share that space with a sponsor whose core business is not necessarily related to the tagged search terms. Thus, sponsors 120 can share the cost of purchasing tags and can form beneficial relationships with other sponsors 120.

To provide the above and other aspects of the tagging system 100, the request unit 140 of the tagging system 100 can receive requests from sponsors 120 and consumers 130 for tag creation. The tagging unit 150 can create tags in response to a tag request. The search unit 160 can search media files accessible by the tagging system 100 and can present media files to users 105, along with applicable tags associated with the media files. The display unit 170 can display media files and their tags to users 105. Further and more detailed aspects of the tagging system 100 and its units are described in more detail below.

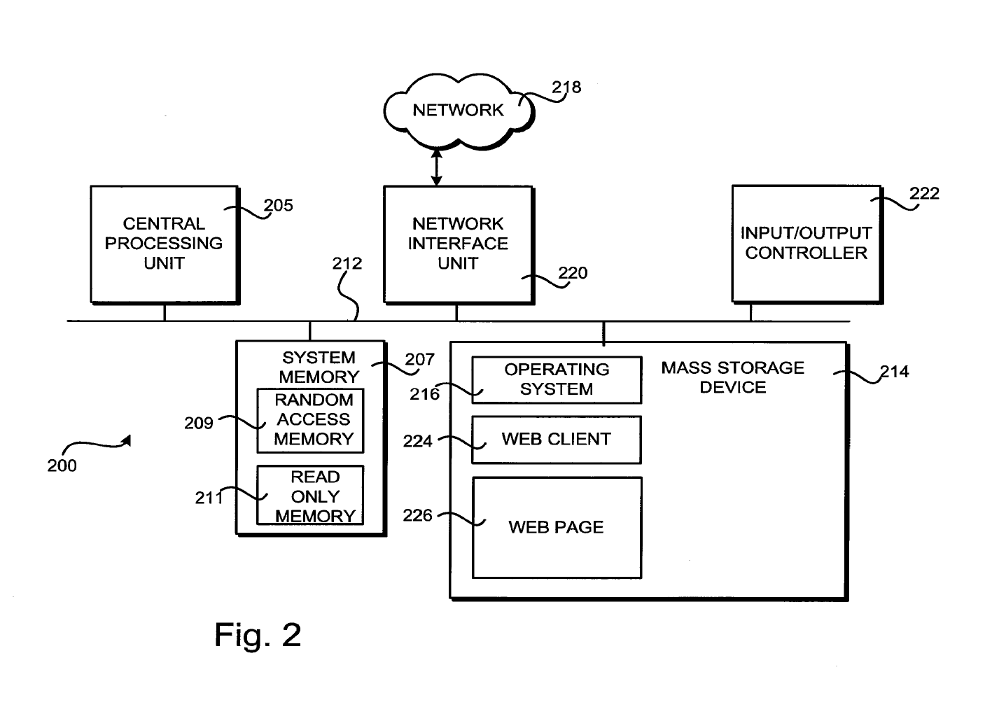

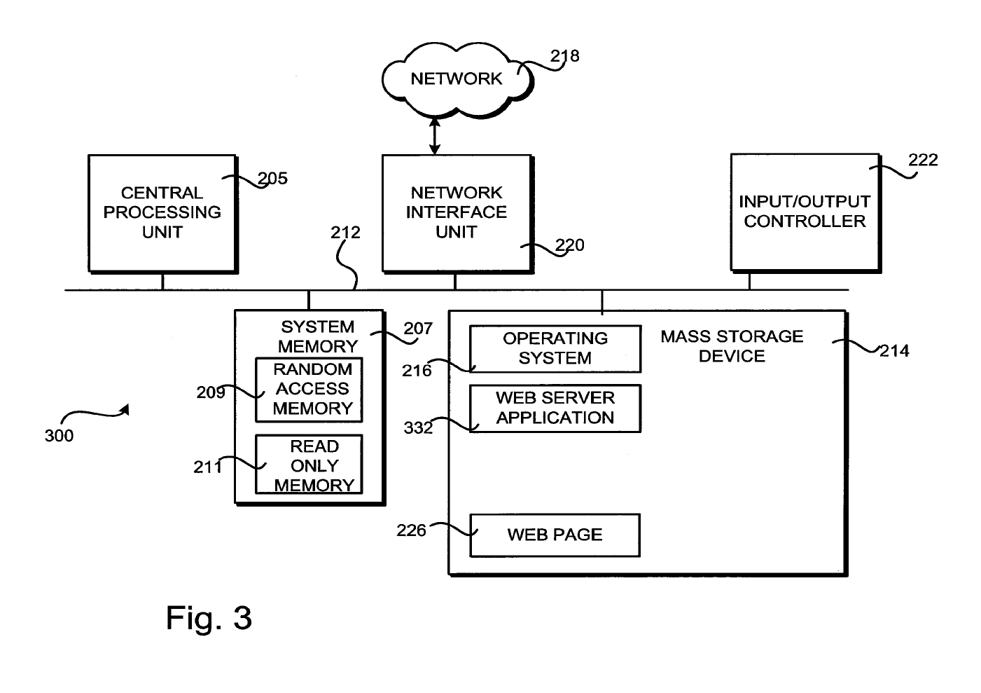

FIGS. 2-3 provide exemplary computer architectures for, respectively, the client computers 200 and the server 300 illustrated in FIG. 1. Those skilled in the art will recognize that the general architectures described in reference to FIGS. 2-3 are for example only, and may be modified to accommodate various embodiments of the tagging system 100 and various operational environments.

FIG. 2 illustrates a computer architecture for a client computer 200, in accordance with an exemplary embodiment of the present invention. The client computer 200 can be used to access the website 110 or otherwise utilize the units of the server assembly 300. As shown in FIG. 2, the client computer 200 can comprise a central processing unit 205 (“CPU”) and one or more system memories 207, such as a random access memory 209 (“RAM”) and a non-volatile memory, such as a read-only memory (“ROM”) 211. The client computer 200 can further comprise a system bus 212 coupling together the memory 207, the processing unit 205, and various other components. A basic input/output system containing routines to assist in transferring information between components of the client computer 200 can be stored in the ROM 211.

The client computer 200 can comprise, or can be associated with, various forms of computer-readable media. One such form of computer-readable media can be embodied in a mass storage device 214. Although the description of computer-readable media contained herein generally refers to a mass storage device 214, such as a hard disk or CD-ROM drive, it will be appreciated by those skilled in the art that computer-readable media can include many available media accessible by the client computer 200. The mass storage device 214 can store an operating system 216, application programs, and other program units. The mass storage device 214 can be connected to the CPU 205 through a mass storage controller (not shown) connected to the bus 212. The mass storage device 214 can provide non-volatile storage for the client computer 200.

Computer-readable media may include computer storage media, such as volatile and non-volatile, removable and non-removable media implemented in many methods or technologies for storage of information, such as computer-readable instructions, data structures, program units, or other data. Computer storage media can include, but is not limited to, RAM, ROM, EPROM, EEPROM, flash memory, other solid state memory technology, CD-ROM, digital versatile disks (“DVD”), other optical storage, magnetic cassettes, magnetic tape, magnetic disk storage, other magnetic storage devices, or many other media that may be used to store the desired data and may be accessible by the client computer 200 or the server assembly 300. Computer-readable instructions on the storage media of the client computer 200 can include, for example, instructions for implementing processes, preferably client-side processes, of the tagging system 100.

According to various embodiments, the client computer 200 can operate in a networked environment using logical connections to remote computers, such as the server assembly 300, through a network 50, such as the Internet. The client computer 200 can connect to the network 50 through a network interface unit 220 connected to the bus 212. It will be appreciated that the network interface unit 220 can also be utilized to connect to other types of networks and remote computer systems.

The client computer 200 can also include an input/output controller 222 for receiving and processing input from a number of other devices, including a keyboard, mouse, or electronic stylus. The input/output controller 222 can provide output to a display screen, a printer, or other type of output device.

A number of program units and data files can be stored in the mass storage device 214 and RAM 209 of the client computer 200. Such program units and data files can also include an operating system 216 suitable for controlling operations of a networked personal computer. A web browser application program, or web client 224, can also be stored on the mass storage device 214 and the RAM 209. The web client 224 can comprise an application program for requesting and rendering web pages 226 created in Hypertext Markup Language (“HTML”) or other markup or browser-readable languages. The web client 224 can be capable of executing client side objects, as well as scripts through the use of a scripting host. The scripting host can execute program code expressed as scripts within the browser environment.

Referring now to FIG. 3, the server assembly 300 utilized in various exemplary embodiments of the tagging system 100 is illustrated. The server assembly 300 can receive and respond to requests from the client computers 200 for operation of the tagging system 100. Those skilled in the art will recognize that the server assembly 300 described in FIG. 3 is an exemplary server configuration and can be modified to accommodate various embodiments of the tagging system 100. As shown in FIG. 3, the server assembly 300 can include many of the conventional computing components included in the client computer 200 and described above with respect to FIG. 2. In particular, the server assembly 300 can include a processing unit 205, a network interface unit 220 connected to the network 50, a system memory 207, and a mass storage device 214, such as the storage device 330.

The mass storage device 214 utilized by the server assembly 300 can typically be operative to store an operating system 216 suitable for servicing the website 110, if applicable, and controlling operations of a server computer. The mass storage device 214 and its associated computer-readable storage media can provide non-volatile storage for the server assembly 300. Computer-readable instructions on computer-readable storage media of the server assembly 300 can include, for example, instructions for implementing processes, preferably server-side processes, of the tagging system 100.

In some embodiments, the server assembly 300 can utilize a web server application 332. The web server application 332 may receive and respond to requests from web clients 224 at remote computers, such as the client computer 200, for web pages 226 located at or accessible to the server assembly 300. It will be appreciated that web pages 126, as described herein, include both those pages stored statically and utilizing only HTML, as well as pages generated dynamically through use of server-side scripting technologies.

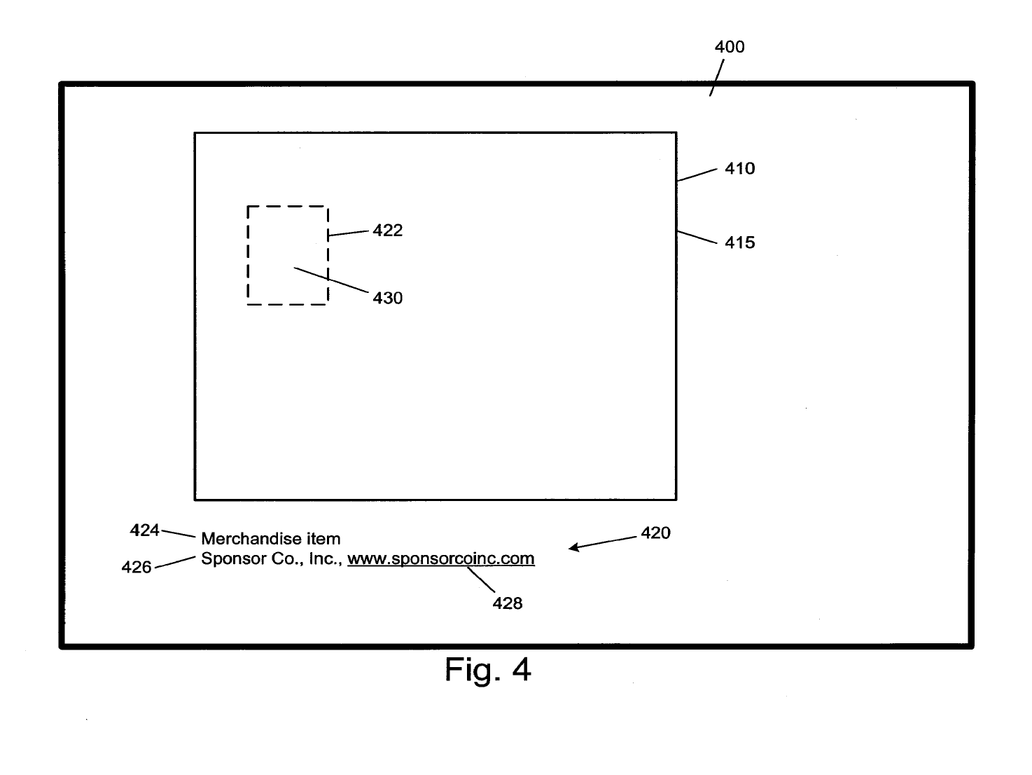

FIG. 4 illustrates a display 400 of a media file 410 tagged by way of the tagging system 100, according to an exemplary embodiment of the tagging system 100. Although the illustrated media file 410 is an image 415, other types of media files 410 can be tagged and displayed through the tagging system 100. For example, and not limitation, a tagged media file 410 can be an audio clip, a video clip, image file, text, multimedia, or combination thereof.

The media file 410 used as a basis for a tag 420 can depict a representation of the intended target 430 of the tag 420. The media file 410 need not reside on the tagging system 100, i.e., need not be stored on a hard drive 330 or other mass storage device 214 of the server assembly 300, so long as the media file 410 is accessible to the tagging system 100. For example, and not limitation, the media file 410 can be stored on a remote system that is accessible to the tagging system 100 through the network 50. In that case, the tagging system 100 can store a web address or other identifier used to locate the media file 410, so that the media file 410 can be displayed by the tagging system 100 to a user 105.

The display 400 providing the media file 410 can be, for examples, a user interface of the client application 115 or a web page of the website 110. As shown in FIG. 4, if the media file 410 is associated with a tag 420, a representation of the tag 420 can be displayed to the user along with the media file 410.

As shown in FIG. 4, in an exemplary embodiment of the tagging system 100, a tag 420 can comprise a section indication 422, a title or description 424, a sponsor indication 426, and a web address 428, some or all of which can be related to the sponsor 120 or target 430 of the tag 420, and some or all of which can be presented to the user to indicate the existence of the tag 420. The section indication 422 can indicate a section of the media file 410 containing the target 430 of the tag 420. The title or description 424 can provide an explanation of the target 430 illustrated or otherwise represented by the media file 410. The sponsor indication 426 can be some indication of a sponsor 120 who provided some compensation to an operator of the tagging system 100 for creation of the tag 420. For example, and not limitation, the sponsor 120 can have paid an operator of the tagging system 100 for the right to be associated with the particular media file 410 or with a collection of media files 410 returned as search results. The web address 428 can be a web page or other web resource, which can be external to the website 110 of the tagging system 100.

The web address 428 can point to, for example, a website that sells the product, a home page of the sponsor, or an information page for the target. The web address 428 can be an address that is either external or internal to the tagging system 100. If an external web address is provided, then the web address can correspond to a resource unaffiliated with the tagging system 100. In some embodiments, the web address 428 can appear to a user viewing the media file 420 as a hyperlink, wherein the user 105 can click on the hyperlink to navigate to the web address 428.

Indication of an associated tag 420 can be provided in the display 400 by many means. For example, and not limitation, the media file 410 can have a pulsing, blinking, or highlighted portion. Alternatively, the media file can include a caption providing information about the tag. A user 105 can access the tag and, accordingly, can view information entered by the user 105. The user can also view and follow any web addresses 428 incorporated into the tag 420.

As shown in FIG. 4, the description 424, sponsor indication 426, and web address 428 can be displayed on or near the media file 420 to indicate that the media file 420 is tagged with this information. The section indication 422 of the tag 420 can be displayed in various manners. For example, the portion of the media file 420 indicated by the section indication 422 can remain outlined or otherwise graphically depicted within the representation of the media file 420, as shown in FIG. 4. Alternatively, the indicated portion of the media file 420 can be outlined or otherwise indicated only when the user 105 clicks on, or hovers over, the displayed representation of the tag 420.

Thus, by presenting a display 400 of the media file 410 and associated tag 420, the tagging system 100 can present a user 105 with various information of the target 430 to the benefit of the sponsor 120. By viewing the tag 420 in association with the media file 410, the user 105 can receive a description 424 of the target 430 and where the target 430 appears in the media file 410, along with information about the sponsor and one or more web addresses 428 providing further information about the target 430. By following the web addresses 428, the user 105 can be provided an opportunity to purchase the target 430 from the sponsor 120 or to otherwise support the sponsor 120.

In an exemplary embodiment of the tagging system 100, before a tag 420 can be associated with a media file, the media file 410 can first be tagged by a user 105, including being either tagged by a sponsor 120 or provisionally tagged by a consumer 110.

To tag a media file 410, a sponsor 120 of the tagging system 100 can select a portion of the media file 410 representing the intended target 430 or can indicate that the tag 420 applies to the media file 410 as a whole. Selection can comprise various means of distinguishing a portion of the media file 410 from the remainder of the media file 410. For example, if the media file is an image 415, selection can occur when the sponsor 120 drags a mouse cursor across the image 415 to outline a portion of the image 415. Alternatively, the sponsor 120 can manually input coordinates of a section of the image representing the target 430. The section indication 422 of the eventual tag 420 can indicate the portion of the media file 410 selected by the sponsor 120.

The tagging system 100 can prompt the sponsor 120 to enter information related to the target 430 of the intended tag 420. The sponsor 120 can be presented with one or more questions or data fields requesting specific or general information about the target 430. The tagging system 100 can request that the sponsor 120 indicate whether the target is a single thing, such as a pair of slacks, or a collection of things, such as an entire outfit. The tagging system 100 can also request that the sponsor 120 select a category for the target 430. Categories can include, for example, people, events, places, and merchandise. Further information can be provided by the sponsor 120 as the sponsor 120 desires. For example, if the target 430 is a piece of merchandise, the sponsor 120 can enter a brand, style, model, line, price, color, edition, or various combinations of details about the target. Alternatively, for another example, if the target 430 is an event, the sponsor 120 can enter a title, date, time, or location for the event.

Given the information received from the sponsor 120 related to the target 430, a search engine can search internal and/or external data files to locate one or more web resources that are relevant to the target 430. For example, if the target 430 is a piece of merchandise, the search engine can locate an official website of the brand of the merchandise. If the target is an event, the search engine can locate a ticket retailer for the event or an official website of the event. If the target 430 is a person, the search engine can locate an internal profile of the person, as well as one or more external bios for the person. In addition to locating official web pages related to the target, the search engine of the tagging system 100 can also locate possibly relevant unofficial websites. For example, the search engine can locate news stories or reviews related to the target. Additionally, for merchandise targets, the search engine can locate one or more eBay® auctions or other discount sellers offering the target for sale.

Web resources identified as relevant to the target can be presented to the sponsor 120 for review. The sponsor 120 can select all or a subset of the identified web resources to be included of the tag 420, or the tagging system 100 can automatically incorporate web addresses 428 of identified web resources into the tag 420 without requesting that the sponsor 120 select or approve a set of the identified websites for incorporation. Additionally or alternatively, the sponsor 120 can indicate a particular one or more web resources for inclusion in the tag 420.

After the sponsor 120 enters data related to the target of the tag, the tagging system 100 can create the tag 420. The tagging system 100 can associate the tag 420 with both the target 430 and the tagged media file 410. Accordingly, when the media file 410 is accessed, such as through the client application 115, the website 110, a social networking system, or a search engine, the media file 410 can be accompanied by an indication that the media file 410 is tagged. Additionally, when a web page associated with the target 430 is accessed, that web page can be accompanied by an indication that the target 430 is tagged in one or more media files 410.

An exemplary embodiment of the tagging system 100 can allow a tag 420 to be created and purchased by a sponsor 120 only when the tag 420 relates to the sponsor's core business or business practices. Tag requests that fail to relate to a requesting sponsor's core business or business practices can be rejected, such that no resulting tag 420 is posted by the tagging system 100. For example, the tagging system 100 can maintain a profile for each sponsor 120, and can reject new tags 420 created by a sponsor when the tagged media file 410, the tag description 424, or both fail to relate to the sponsor's business, as indicated by the sponsor's profile.

In some embodiments of the tagging system 100, a sponsor 120 wishing to tag a media file 410 can place a bid on the tag 420, either before or after specifying details about the tag 420, such as the section indication 422, the description 424, the sponsor indication 426, or the web address 428. If multiple sponsors 120 bid on a single specific media file 410, the tagging system 100 can select the most favorable of the received bids for the media file 410 and can tag the media file 410 with a tag 420 of the corresponding sponsor 120. Some embodiments can provide for a bidding period for a media file 410. During the bidding period, the tagging system 100 can receive bids for the right to sponsor a particular media file 410. The tagging system 100, specifically, for example, the request unit 140 of the tagging system 100, can identify the most favorable bid for the media file 410 and can accept that bid by allowing the corresponding sponsor to tag the media file 410. The most favorable bid can be the bid for the highest price or otherwise providing terms most beneficial to the operator of the tagging system 100.

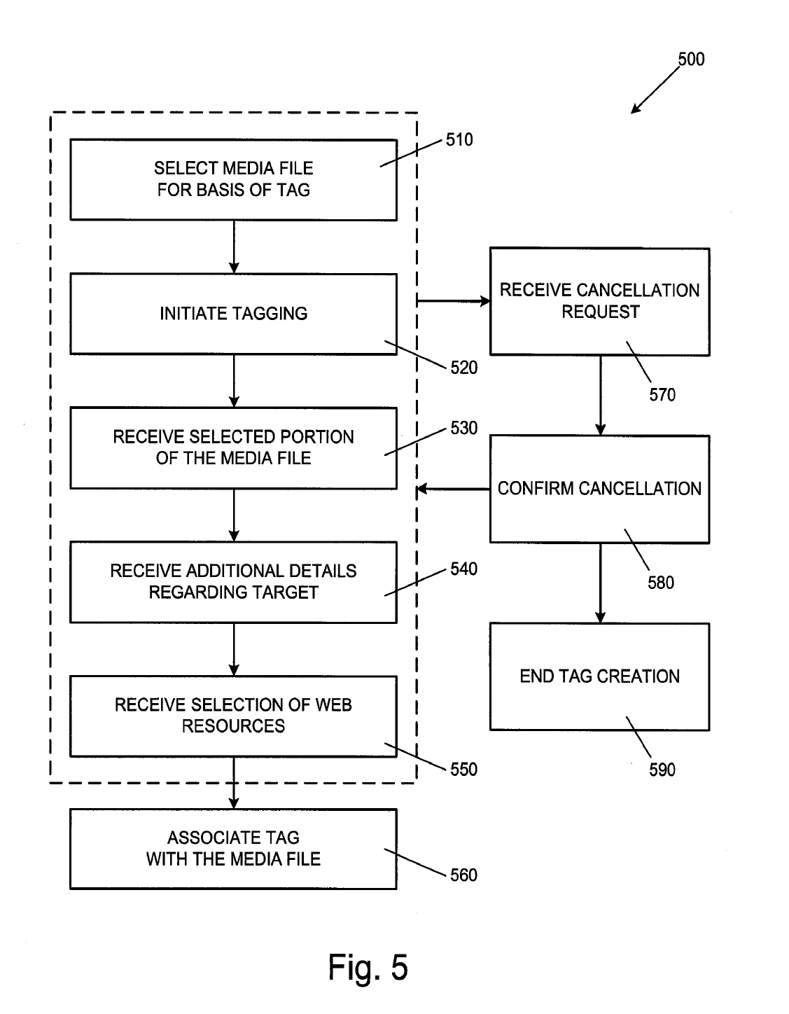

FIG. 5 illustrates a flow chart of tagging process 500 of the tagging system 100, according to an exemplary embodiment of the present invention. As shown in FIG. 5, at 510, a media file 410 can be selected to be used as the basis of a tag 420. At 520, a user 105, such as a sponsor 120, can initiate tagging by indicating to the tagging system 100 an intention to create a tag 420. Such indication can occur by the user's clicking a provided link or button, or outlining a selected portion of the media file 410 to be included in the section indication 422 of the tag 420. At 530, the user 105 can select a portion of the media file 410 representing a target 430 of the tag 420, if this step was not performed already to initiate tag 420 creation. In an exemplary embodiment, when the media file 410 is an image 415, selection of a particular portion of the media file 410 representing the target 430 can occur when the user 105 drags a mouse cursor across the image 415 to highlight a portion of the image 415. In response to prompts from the tagging system 100, the user 105 can enter additional details relating to the target at 540. At 550, the user 105 can select one or more web addresses 428 to be included in the tag 420. When the tagging process 500 completes at 560, the tag 420 can be created and associated with the media file 410.

During the tagging process 500, the user 105 can opt to cancel tag creation at various points during the process 500. If the user 105 indicates a desire to cancel tag creation, such as at 570, the user 105 can be presented with a confirmation dialog at 580. If the user 105 confirms cancellation, the tagging process 500 ends at 590 without creation of the tag 420. If the user 105 indicates a desire to continue with tag 420 creation, the confirmation dialog can close, and the user 105 can continue tag 420 creation at the current position in the tagging process 500.

In some exemplary embodiments of the tagging system 100, tags 420 can be created only or primarily by sponsors 120. In such embodiments, consumers 130 can create provisional tags 420, which are not available for viewing by other users 105 until accepted and, if applicable, purchased by sponsors 120. The same or similar steps can be followed by a consumer 130 when provisionally creating a tag 420 as are followed by a sponsor 120 when creating a tag 420. Those steps can be, for example, and not limitation, those provided in FIG. 5 and the above description of FIG. 5. When a provisional tag 420 is created, however, it does not become an accepted tag 420, i.e., visible by general users 105 of the tagging system 100, until accepted by a sponsor 120.

A provisional tag 420 can be directed toward a specific sponsor 120, in which case that specific sponsor 120 can be indicated by the consumer 130 who creates the provisional tag 420. The specific sponsor 120 can then view the tag 420 and have the opportunity to purchase or bid on the provisional tag 420. If no specific sponsor 120 is indicated for a provisional tag 420, then one or more sponsors 120 whose core business is related to the target 430 of the provisional tag 420 can view or be notified of the provisional tag 420, so as to purchase or bid on the provisional tag 420.

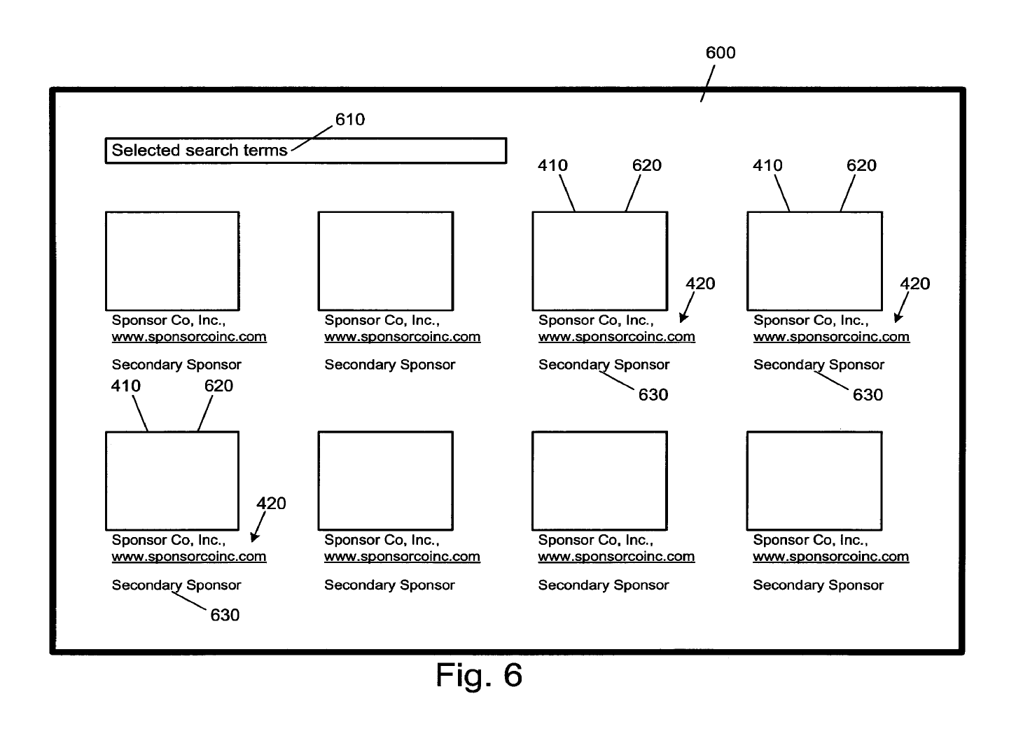

In addition, or alternatively, to enabling tagging of media files 410 specifically selected by users 105, the tagging system 100 can enable sponsors 120 to tag 420 a collection of media files 410 that are returned as search results. Conventionally, a search engine can return a collection of images related to search terms entered by a user. According to some embodiments of the present invention, the tagging system 100 can associate tags 420 with a collection of media files 410 returned as search results. A sponsor 120 can purchase a tag 420 for predetermined search terms 610, and the tagging system 100 can thus associate a tag 420 of the sponsor with some or all of the search results 620 provided to a user 105 who enters those predetermined search terms 610. FIG. 6 illustrates an exemplary display 600 of search results 620 provided by the tagging system 100 in response to a user's entering tagged search terms 610.

The tagged search terms 610 can be one or more words or phrases selected by the sponsor 120. In some exemplary embodiments, the tagging system 100 can require that the tagged search terms 610 be related to the tagging sponsor's core business. As a result, users 105 are not inconvenienced with irrelevant tags 420 when submitting searches, which might discourage users 105 from using the search engine and the tagging system 100 in the future. Thus, for example, each sponsor 120 can maintain a profile with the tagging system 100 indicating the sponsor's core business or business practices. When a sponsor 120 attempts to purchase a tag 420 for search terms 610, the tagging system 100 can accept or refuse to provide the tag 420 based on the business indications in the sponsor's profile.

Application of a tag 420 to search results 620 based on tagged search terms 610 can vary based on the tagging agreement between the sponsor 120 and the tagging system 100. For example, and not limitation, the tag 420 for the search terms 610 can be applied to a predetermined set of search results 620 returned in a search that includes the tagged search terms 610. The set of search results 620 can be defined as a predetermined number of search results 620 or a predetermined number of pages of search results 620. For example, the first one or more search results can be tagged, the first one or more pages of search results can be tagged, or a non-consecutive number of search results 620 or pages of search results 620 can be tagged.

When a user 105 submits a search that includes the tagged search terms 610, the tagging system 100 can apply tags 420 to search results 620, such as those tags 420 shown in FIG. 6. In the embodiment of FIG. 6, the entire page of search results 620 is illustrated as tagged, and the tags 420 resulting from the tagged search terms 610 can be visible beneath, or otherwise associated with, each search result individually. Alternatively, for example, if the tag 420 is to be applied to a predetermined number of search results 620, all search results 620 on the page need not be tagged, as only those counted in the predetermined number need include the tag 420.

The tagging system 100 can enable spot-sharing for search results 620 when requested by a sponsor 120 of tagged search terms 610. When spot-sharing is provided, a secondary tag 630 can be associated with, and displayed near, media files 410 returned as search results 620 corresponding to tagged search terms 610. The secondary tag 630 can be purchased by a secondary sponsor 120 and, analogous to the primary tag 420, can include an external web address 428 selected by the secondary sponsor 120.

The secondary sponsor 120 need not have a core business or business practices that are directly related to the tagged search terms 610. Instead, the secondary sponsor 120 can share the tag of the primary sponsor 120, which can be required to have a core business related to the tagged search terms 610. The secondary sponsor 120 can share the burden of paying for the tag 420 applied to the search results 620. Because the tag 420 can primarily belong to the primary sponsor 120, the primary sponsor 120 can select or approve the secondary sponsor 120. Thus, spot-sharing can build relationships between sponsors 120 can enable various sponsors 120 to more ably afford to tag search terms 610, and thus search results 620.

Additionally or alternatively to provisional tagging, the tagging system 100 can provide other means for notifying a potential sponsor of a media file 420 that the potential sponsor 120 might like to tag. For example, tag requests can be submitted to the tagging system 100 by users, such as through a “lost and found” system, and the tag requests can be accessible to potential sponsors for consideration.

When a user 105 encounters a media file 410 accessible to the tagging system 100, the user 105 can submit a tag request to the tagging system 100 for the media file 420. To submit the request, the user can provide the tagging system 100 with, at least, a location or other indication of the media file 410. If the media file 410 is stored on the tagging system 100, or accessed through the tagging system 100, the user can simply make some indication of the tag request while viewing the media file 410, but other means of indicating the media file 410 to which a tag request pertains can be implemented as well. If the media file 410 is not yet accessible to the tagging system 100, the user 105 can submit the media file 410 to the tagging system 100 along with the tag request. The tag request can represent a request for additional information about the media file 420 or about a particular aspect of the media file 420. Tag requests can be useful in various scenarios. For example, if a user 105 has forgotten a person's name, the user can submit a photograph of the person in a tag request indicating that an identity of the depicted person is desired. Alternatively, if a user 105 has a photograph of a group of people, one of whom is wearing a tie that the user 105 would like to purchase, the user 105 can submit a tag request along with the photograph.

In submitting a tag request, the user 105 can optionally indicate a specific portion of the media file 410, a question or statement related to the request, or both. For example, if the media file 410 is an image 415, the user can select a portion of the image 415 to which the tag request pertains. In the previous example, the user can select the portion of the image containing the tie. The user can also submit a question, such as, “Where can I purchase this tie?” If submitted the selected portion of the image and the question or statement can be included in the tag request, when the request is later viewed by potential sponsors.

The tagging system 100 can store the tag request with a reference to the user 105 who submitted the request, so that the requesting user can be contacted when responses to the tag request are received. Additionally, other users 105 who view the tag request can indicate that they would also like to be contacted when responses are received.

When a tag request is initially submitted, it can be marked as “open.” An open tag request can be a tag request for which the requesting user 105 is still awaiting a response. A sponsor 120 can respond to an open tag request by creating a tag 420 based on the provided media file 410, in compliance with the tag request. When a response to a tag request is received, the requesting user can be notified of the newly created tag 420. Other users 105 requesting notification can also be notified of the newly created tag 420. In some embodiments of the tagging system 100, receipt of a response can automatically close the tag request. In some other embodiments, however, the tag request is only closed when the requesting user 105 indicates that the tag request should be closed. In some embodiments, a provisional tag 420 can also be accepted as a response to a tag request, or can result in a notification being sent to the requesting user 105 without closing the tag request.

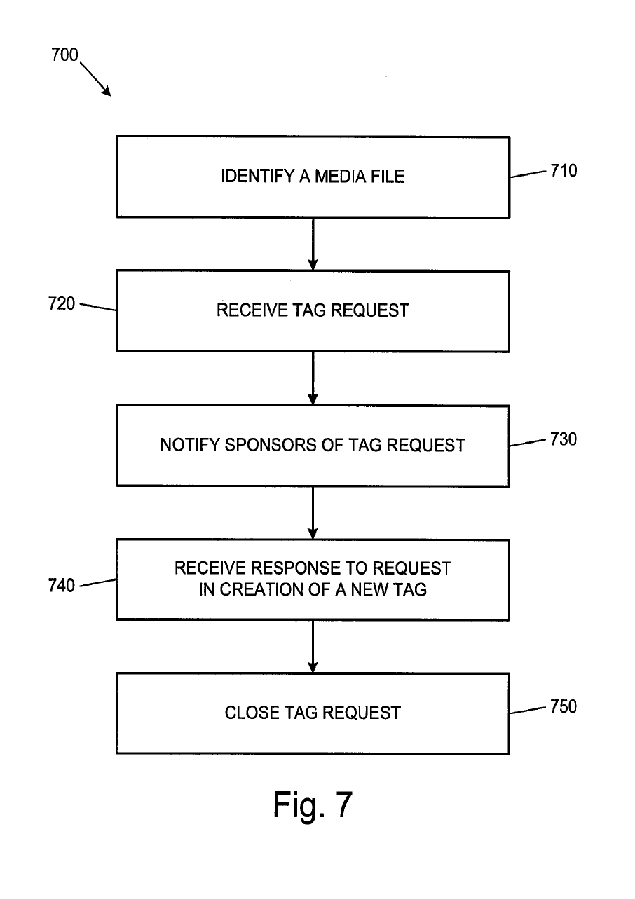

FIG. 7 illustrates a flow chart of a method 700 of opening and closing a tag request. At 710, a user 105 can identify a media file 410. At 720, the user 105 can submit a tag request to the tagging system 100, along with an indication of the media file 410 and a description of what is requested to be identified. At 730, the tagging system 100 can notify all or selected sponsors 120 of the tag request. If selected sponsors 120 are notified, then a particular sponsor 120 can be selected if the sponsor's core business related to the description in the tag request. At 740, a sponsor can respond to the tag request by creating a tag 420 associated with the media file 410 that is the subject of the tag request. At 750, the tagging system 100 can close the tag request in response to the newly created tag 420.

Accordingly, various embodiments of the tagging system 100 can provide robust tagging that can facilitate networking and marketing to the benefit of sponsors utilizing the tagging system 100, as well as to the benefit of operators of the tagging system 100.

While the invention has been disclosed in exemplary forms, many modifications, additions, and deletions can be made without departing from the spirit and scope of the invention and its equivalents, as set forth in the following claims.

1. A computer program product embodied in a computer-readable medium, the computer program product comprising an algorithm adapted to effectuate a method for robust tagging, the method comprising:
receiving an indication of a media file representing a target;
providing a sponsor account associated with a sponsor;
configuring the sponsor account to enable the sponsor to tag targets as products sold by the sponsor;
receiving an identification of the target from the sponsor via the sponsor account;
receiving a description related to the target;
creating a robust tag including at least the description;
associating, with a computer processor, the robust tag with the media file in exchange for payment from the sponsor; and
displaying a portion of the robust tag when the media file is displayed.

2. (canceled)

3. (canceled)

4. (canceled)

5. The computer program product of claim 1, the indication of the media file and the description being provided by a consumer other than the sponsor, wherein the sponsor approves creation of the robust tag.

6. The computer program product of claim 5, wherein the sponsor compensates the consumer for suggesting creation of the robust tag.

7. (canceled)

8. The computer program product of claim 1, wherein the indication of the media file is received from a consumer requesting identification of the target, and wherein creation of the tag identifies the target and occurs after the sponsor responds to the consumer's request for identification of the target.

9. (canceled)

10. The computer program product of 1, the method further comprising including a web address in the robust tag, the web address leading to an external web page selected by the sponsor where the user can purchase goods or services related to the target.

11. (canceled)

12. (canceled)

13. The computer program product of claim 1, the target being a merchandise article, a service, or an event or a location

14. (canceled)

15. (canceled)

16. The computer program product of claim 1, the method further comprising:
conducting a web search based on the description of the target to identify one or more web pages related to the target;
including in the robust tag a hyperlink to at least one of the identified web pages.

17. The computer program product of claim 1, the method further comprising receiving a bid from the sponsor for creation of the robust tag.

18. The computer program product of claim 17, the method further comprising:
receiving one or more other bids from one or more other potential sponsors; and
selecting the sponsor's bid over the other bids for creation of the robust tag.

19. The computer program product of any of the preceding claims, wherein creating a robust tag comprises verifying that the sponsor meets certain criteria related to the target.

20. The computer program product of claim 19, wherein creating a robust tag comprises verifying that the target is related to a core business practice of the sponsor.

21. A tagging system comprising:
a request unit for receiving a new tag request from a sponsor, the new tag request comprising a web address indicating an external website related to the target and affiliated with the sponsor, and the new tag request including payment for creation of a robust tag;
a tagging unit configured to create the robust tag, with a computer processor, wherein the robust tag includes the web address, and is further configured to associate the robust tag with one or more media files; and
a display unit configured to display a representation of the robust tag with the media files in exchange for the payment received for creation of the robust tag;
the request unit being further configured to receive a selection of search terms, and the media files associated with the robust tag being a collection of search results provided in response to a search that includes the selection of search terms.

22. (canceled)

23. The tagging system of claim 21, the target comprising an article of merchandise, and the sponsor being a retailer or producer of the target article of merchandise.

24. The tagging system of claim 21, the target comprising an event, a location, goods, or services.

25. The tagging system of claim 21, the target being related to a business practice of the sponsor.

26. The tagging system of any of claims 21-25, the tagging system rejecting the tag request if the sponsor fails to meet certain criteria related to the target.

27. (canceled)

28. (canceled)

29. The tagging system of claim 21, the robust tag being associated with the media files dynamically when the search is conducted and the media files are identified as being related to the search terms.

30. (canceled)

31. The tagging system of claim 21, the display unit further configured to associate the robust tag with a predetermined number of media files or a predetermined number of pages of media files in the search results of the search.

32. A method comprising:
receiving from a first user an indication of a media file representing a target;
receiving from the first user a request for identification of the target represented by the media file;
accepting a plurality of bids from a plurality of potential sponsors for creation of a robust tag for the target;
selecting the bid of a first sponsor;
creating, with a computer processor, the robust tag associated with the media file and identifying the target represented by the media file, in exchange for compensation from the first sponsor;
displaying a representation of the robust tag with the media file; and
including a name or description of the first sponsor in the robust tag.

33. The method of claim 32, further comprising notifying a second user of the identification request if a business practice of the second user is related to the identification request.

34-39. (canceled)
